(19) United States
(12) Patent Application Publication
(10) Pub. No.: US 2024/0327161 A1
(43) Pub. Date: Oct. 3, 2024

(54) CONTINUOUS TAPE FEEDER AND CONTINUOUS TAPE FEEDING METHOD

(71) Applicant: SAMSUNG SDI CO., LTD., Yongin-si (KR)

(72) Inventors: Moonsoo CHEON, Yongin-si (KR); Heejin JUNG, Yongin-si (KR)

(21) Appl. No.: 18/611,901

(22) Filed: Mar. 21, 2024

(30) Foreign Application Priority Data
Mar. 27, 2023 (KR) 10-2023-0039821
May 18, 2023 (KR) 10-2023-0064308

(51) Int. Cl. B65H 19/18; B65C 9/18; B65C 9/42; B65H 19/20; B65H 26/00

(52) U.S. Cl. CPC B65H 19/18; B65C 9/1803; B65C 9/42; B65H 19/20; B65H 26/00; B65H 2301/46014; B65H 2301/46172; B65H 2301/463; B65H 2301/541; B65H 2553/42

(57) ABSTRACT

A continuous tape feeder includes a first tape fixing roll configured to feed a first tape, a second tape fixing roll configured to feed a second tape, a fuser adjacent to the first tape fixing roll, the fuser being configured to connect the first tape to the second tape through fusion to form a connection portion, a cutter between the fuser and the first tape fixing roll, the cutter being configured to cut a first tape portion between the connection portion and the first tape fixing roll, and a controller configured to determine a timing for operating the fuser and the cutter.

### CROSS-REFERENCE TO RELATED APPLICATIONS

The present application claims priority and the benefit of Korean Patent Application No. 10-2023-0039821, filed on Mar. 27, 2023, and Korean Patent Application No. 10-2023-0064308, filed on May 18, 2023, in the Korean Intellectual Property Office, the entire disclosures of which are incorporated herein by reference.

### BACKGROUND

### 1. Field

One or more embodiments relate to a continuous tape feeder and a continuous tape feeding method, and more particularly, to an apparatus and method for continuously feeding a tape used in a process of producing a battery pack.

### 2. Description of the Related Art

In a process of manufacturing a battery pack including a small battery cell, e.g., a mobile phone battery pack or a coin cell battery pack, a tape is often attached to the battery pack for insulation, etc. When the tape is attached to the battery pack, a tape material may be wound around a battery pack production facility (e.g., apparatus or machinery) in the form of a roll to continuously feed the tape.

### SUMMARY

According to one or more embodiments, a continuous tape feeder includes a first tape fed through a first tape fixing roll, a second tape fed through a second tape fixing roll, a fusing unit configured to connect the first tape to the second tape through fusion to form a connection portion, a cutting unit configured to cut a first tape portion between the connection portion and the first tape fixing roll, and a controller configured to determine a timing for operating the fusing unit and the cutting unit.

The continuous tape feeder according to embodiments of the present disclosure may further include a first load cell portion configured to detect a load of the first tape wound around the first tape fixing roll.

In the continuous tape feeder according to embodiments of the present disclosure, the first load cell portion may be further configured to transfer the detected load to the controller, and the controller may be further configured to operate the fusing unit and the cutting unit in response to the load of the first load cell portion being less than or equal to a preset value.

The continuous tape feeder according to embodiments of the present disclosure may further include a label adsorbing unit configured to adsorb a label attached to the first tape and the second tape and a vision camera unit arranged adjacent to the label adsorbing unit and configured to detect feeding of the label.

In the continuous tape feeder according to embodiments of the present disclosure, the vision camera unit may be further configured to count a number of labels to be fed to the label adsorbing unit and transfer the counted number of labels to the controller, and the controller may be further configured to operate the fusing unit and the cutting unit in response to the number of labels being greater than or equal to a preset value.

The continuous tape feeder according to embodiments of the present disclosure may further include an alarming unit configured to generate an alarm according to a signal generated by the controller if it is determined that the fusing unit and the cutting unit need to operate.

The continuous tape feeder according to embodiments of the present disclosure may further include a tape transfer roll configured to transfer, after the label attached to the first tape and the second tape is fed, the first tape and the second tape from which the label is removed.

In the continuous tape feeder according to embodiments of the present disclosure, the first tape and the second tape are arranged to pass through the fusing unit.

In the continuous tape feeder according to embodiments of the present disclosure, the first tape fixing roll and the second tape fixing roll may respectively include a first tape guide roll and a second tape guide roll configured to transfer paths of the first tape and the second tape.

According to one or more embodiments, a continuous tape feeding method includes feeding a first tape wound around a first tape fixing roll to a product assembling unit and feeding a label formed on the first tape to the product assembling unit, determining, by a controller, whether a timing for tape replacement occurred, connecting, by a fusing unit, the first tape to the second tape through fusion to form a connection portion, cutting, by a cutting unit, the first tape, and feeding the second tape wound around a second tape fixing roll to the product assembling unit and feeding a label formed on the second tape.

In the continuous tape feeding method according to embodiments of the present disclosure, the determining, by the controller, whether the timing for tape replacement occurred may include measuring, by a load cell portion, a load of the first tape fixing roll and determining, by the controller, that the timing for tape replacement occurred, in response to the load of the first tape fixing roll, detected by the load cell portion, being less than or equal to a preset value.

In the continuous tape feeding method according to embodiments of the present disclosure, the determining, by the controller, whether the timing for tape replacement occurred may include counting, by a vision camera unit, a number of labels to be fed to a label adsorbing unit and determining, by the controller, that the timing for tape replacement occurred, in response to a number of labels counted by the vision camera unit being greater than or equal to a preset value.

The continuous tape feeding method according to embodiments of the present disclosure may further include cutting, by the cutting unit, the first tape portion between the connection portion and the first tape fixing roll.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a perspective view schematically showing a continuous tape feeder according to embodiments of the present disclosure;

FIG. 2 is a view showing a state where a controller determines a replacement timing for a tape and an alarming unit generates an alarm, according to embodiments of the present disclosure;

FIG. 3 is a view showing an operation where a fusing unit connects a first tape to a second tape through fusion to form a connection portion, according to embodiments of the present disclosure;

FIG. 4 shows a state where a cutting unit cuts a first tape;

FIG. 5 shows a state where a label of a second tape is fed to a product assembling unit;

FIG. 6 is a block diagram showing a structure of a continuous tape feeder according to embodiments of the present disclosure; and

FIG. 7 is a flowchart showing a continuous tape feeding method according to embodiments of the present disclosure.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. In addition, it will also be understood that when a layer is referred to as being “between” two layers, it can be the only layer between the two layers, or one or more intervening layers may also be present. Like reference numerals refer to like elements throughout.

As used herein, the term “and/or” includes any and all combinations of one or more of the associated listed items. Further, in the following embodiments, the terms first, second, etc., have been used to distinguish one component from other components, rather than limiting.

In the following embodiments, singular forms include plural forms unless apparently indicated otherwise contextually. In the following embodiments, the terms “include”, “have”, or the like, are intended to mean that there are features, or components, described herein, but do not preclude the possibility of adding one or more other features or components.

If a certain embodiment may be implemented otherwise, a particular process order may be performed differently from the order described. For example, two processes described in succession may be performed substantially simultaneously, or may be performed in an order reverse to the order described.

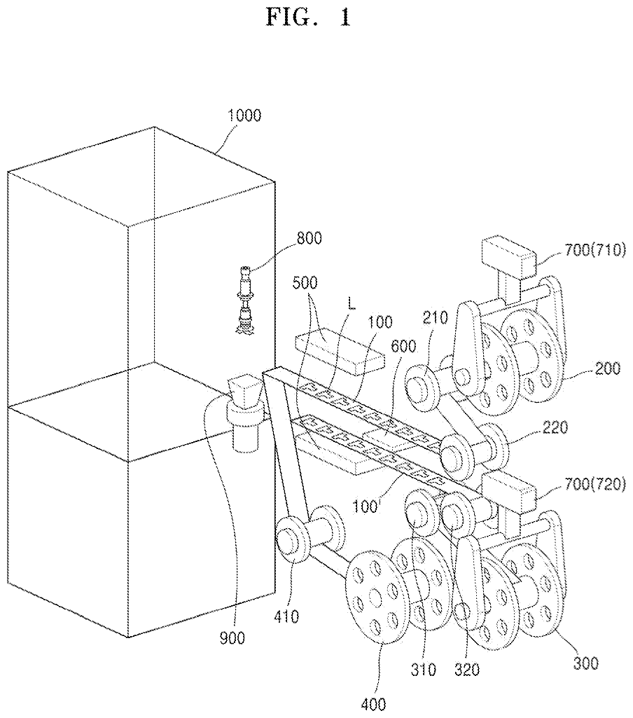

Hereinbelow, a continuous tape feeder according to embodiments of the present disclosure will be described with reference to FIGS. 1 to 6.

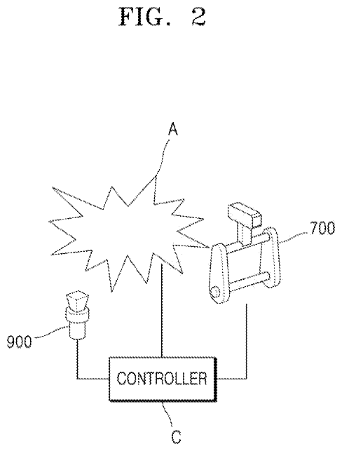

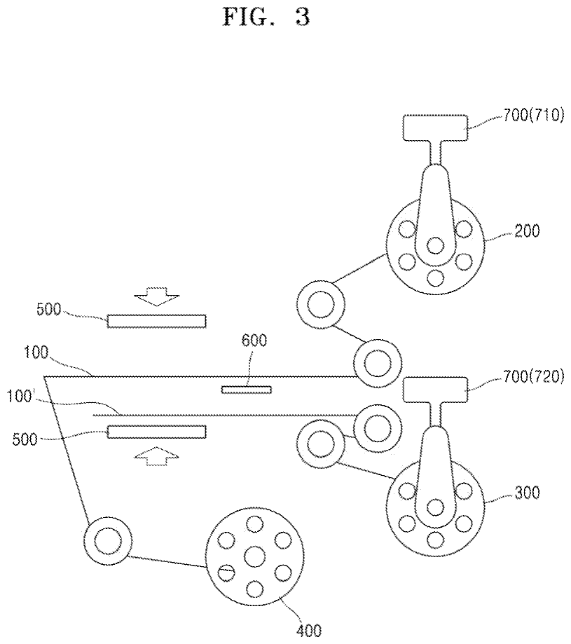

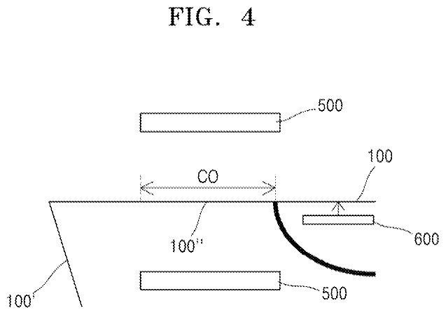

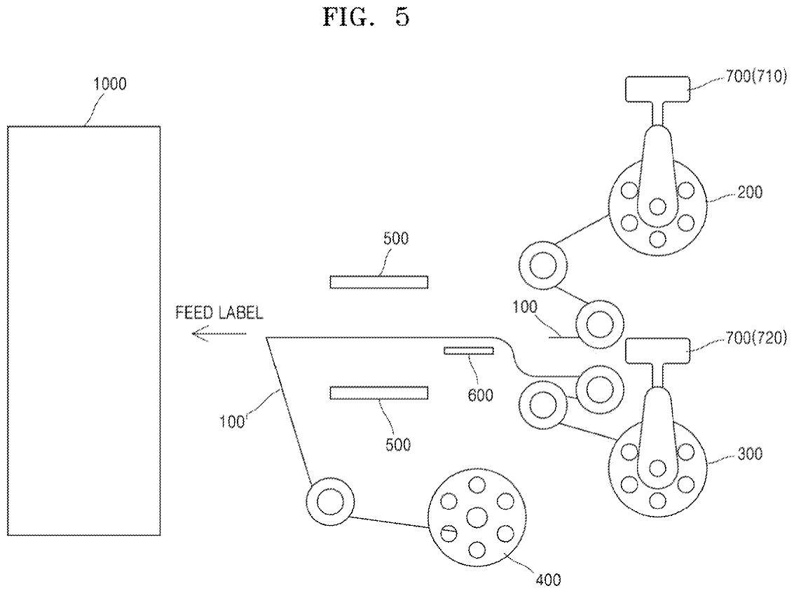

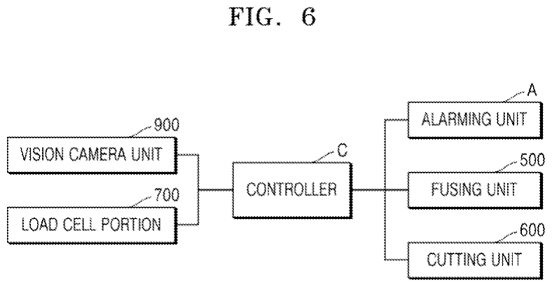

FIG. 1 is a perspective view schematically showing a continuous tape feeder according to embodiments. FIG. 2 is a view showing a state where a controller determines a replacement timing for a tape and an alarming unit generates an alarm, according to embodiments. FIG. 3 is a view showing an operation where a fusing unit connects a first tape to a second tape through fusion to form a connection portion, according to embodiments. FIG. 4 shows a state where a cutting unit cuts a first tape. FIG. 5 shows a state where a label of a second tape is fed to a product assembling unit. FIG. 6 is a block diagram showing a structure of a continuous tape feeder according to embodiments.

Referring to FIGS. 1 to 6, a continuous tape feeder according to embodiments of the present disclosure may include a first tape 100 fed through a first tape fixing roll 200, a second tape 100′ fed through a second tape fixing roll 300, a fusing unit 500 (e.g. a fuser) that connects the first tape 100 to the second tape 100′ through fusion to form a connection portion CO, a cutting unit 600 (e.g., a cutter) that cuts a part of the first tape 100 between the connection portion CO and the first tape fixing roll 200, and a controller C that determines operating times of the fusing unit 500 and the cutting unit 600.

According to the current embodiments, tapes may be connected using a fusion method, e.g., thermal fusion, ultrasonic fusion, etc., instead of manual replacement of a general tape roll material or a continuous tape feeding structure using a connecting tape, so implementation of a continuous tape feeder capable of more simply and efficiently connecting tapes than a general tape connection scheme may be possible.

A plurality of labels L may be consecutively attached to the first tape 100 and the second tape 100′. Herein, the label L of the tape may be fed to a product assembling unit 1000 (e.g., a product assembler), and may be attached to a small battery pack in the product assembling unit 1000. If the label L is fed to the product assembling unit 1000, a label adsorbing unit 800 (e.g., a label adsorber) may remove the label L from the first tape 100 and the second tape 100′ to feed the label L to the product assembling unit 1000.

The first tape 100 may be a tape fed to the product assembling unit 1000 to produce the current product (e.g., to produce small battery packs). The second tape 100′ may be a tape prepared for provisional feeding in case that the first tape 100 is exhausted (e.g., used up).

The first tape 100 may be wound around the first tape fixing roll 200 and sequentially wound by first tape guide rolls 210 and 220, and a feeding position of the first tape 100 may be specified. The first tape guide rolls 210 and 220 may set a transfer path of the first tape 100. Likewise, the second tape 100′ may be wound around a second tape fixing roll 300 and sequentially wound by second tape guide rolls 310 and 320, and a feeding position of the second tape 100′ may be specified. The second tape guide rolls 310 and 320 may set a transfer path of the second tape 100′. For example, as illustrated in FIG. 1, the first and second tape fixing rolls 200 and 300 may be arranged vertically above each other, with the first tape guide rolls 210 and 220 and the second tape guide rolls 310 and 320 arranged therebetween, e.g., so the first and second tapes 100 and 100′ extend horizontally between the first and second tape fixing rolls 200 and 300. For example, as illustrated in FIG. 1, the first tape guide rolls 210 and 220 and the second tape guide rolls 310 and 320 may be arranged to define the transfer paths for the first tape 100 and the second tape 100′ through the fusing unit 500, i.e., between the upper and lower fusing units of the fusing unit 500.

If the controller C determines a replacement timing for a tape, the controller C may control the fusing unit 500 to fuse the first tape 100 and the second tape 100′ to connect them into one. In detail, as illustrated in FIG. 1, the fusing unit 500 may be positioned between the product assembling unit 1000 and the first and second tape fixing rolls 200 and 300. The fusing unit 500 may include the upper fusing unit and the lower fusing unit, and if the first tape 100 and the second tape 100′ enter a space between the upper fusing unit and the lower fusing unit, then the upper and lower fusing units of the fusing unit 500 may move toward each other with the first and second tapes 100 and 100′ therebetween to compress the first tape 100 and the second tape 100′ (e.g., up and down) to fusion-bond the first tape 100 and the second tape 100′ to each other. In this case, fusion may include thermal fusion or ultrasonic fusion. By connecting tapes through fusion, the quality of tape connection may be improved and productivity may be enhanced, e.g., compared to manual tape connection using a joint tape, etc.

The first tape guide rolls 210 and 220 may guide the transfer path of the first tape 100, e.g., through a conveyor, a production line, or between rolls, to allow the first tape 100 to pass through a space between the upper and lower fusing units of the fusing unit 500. The second tape guide rolls 310 and 320 may guide the transfer path of the second tape 100′, e.g., through a conveyor, a production line, or between rolls, to allow the second tape 100′ to pass through a space between the upper and lower fusing units of the fusing unit 500.

In the space between the upper and lower fusing units of the fusing unit 500, the first tape 100 and the second tape 100′ may be disposed to overlap each other. In such a state of the first tape 100 and the second tape 100′ disposed to overlap each other, the fusing unit 500 may be driven by a signal of the controller C to fusion-bond the first tape 100 and the second tape 100′, thereby forming the connection portion CO where a fused tape 100″ is formed (FIG. 4).

After the first tape 100 and the second tape 100′ are fusion-bonded, the cutting unit 600 may cut the first tape 100 part, as shown in FIG. 4. More specifically, referring to FIGS. 3 and 4, the cutting unit 600 may be disposed between the fusion-bonded connection portion CO and the first tape fixing roll 200, e.g., between the fusing unit 500 and the first tape fixing roll 200, to cut the first tape 100 between the connection portion CO and the first tape fixing roll 200 (after the first and second tapes 100 and 100′ are fused and the connection portion CO is formed). In this case, after the first tape 100 is cut, as shown in FIG. 5, the second tape 100′ supplied from the second tape fixing roll 300 may be continuously supplied in succession to the first tape 100 to the product assembling unit 1000.

According to the current embodiment, a first load cell portion 710 of the load cell portion 700 may be further provided to detect a load of the first tape 100 wound around the first tape fixing roll 200. The first load cell portion 710 may transfer the detected load to the controller C which may operate the fusing unit 500 and the cutting unit 600 if the load of the first load cell portion 710 is a preset value or less, e.g., in response to a comparison between the load of the first load cell portion 710 and the preset value.

Referring to FIG. 1, the first tape fixing roll 200 may be mounted on the first load cell portion 710. More specifically, in the first tape fixing roll 200, a roll center portion around which the first tape 100 is wound may be connected to the first load cell portion 710. The load cell portion 710 may measure a weight of the first tape 100 wound around the roll center portion of the first tape fixing roll 200, e.g., in accordance with used up tape.

As such, by measuring the weight of the first tape 100 wound around the first tape fixing roll 200 in a production process of a battery pack, an available feeding quantity of the first tape 100 to be fed to the product assembling unit 1000 may be determined. The first load cell portion 710 may transfer weight information of the first tape 100 wound around the first tape fixing roll 200 to the controller C in real time, such that the controller C may identify the weight of the first tape 100 wound around the first tape fixing roll 200 in real time. If the weight of the first tape fixing roll 200 is less than or equal to a preset weight value, based on the weight information of the first tape fixing roll 200 transferred through the first load cell portion 710, the controller C may determine that a timing for tape replacement has occurred, and operate the fusing unit 500 and the cutting unit 600 to replace the first tape 100 with the second tape 100′, and to feed the second tape 100′ to the product assembling unit 1000. As the timing for tape replacement may be accurately determined by measuring in real time the weight of the first tape 100 to be fed, a tape may be continuously fed to the product assembling unit 1000.

According to one or more embodiments, the second tape fixing roll 300 may be mounted on a second load cell portion 720 of the load cell portion 720. More specifically, in the second tape fixing roll 300, the roll center portion around which the tape is wound may be connected to the second load cell portion 720. The second load cell portion 720 may measure the weight of the second tape 100′ wound around the roll center portion of the second tape fixing roll 300.

As such, by measuring the weight of the second tape 100′ wound around the second tape fixing roll 300 in the production process of the battery pack, an available feeding quantity of the second tape 100′ to be fed to the product assembling unit 1000 may be determined. The second load cell portion 720 may transfer weight information of the second tape 100′ wound around the second tape fixing roll 300 to the controller C in real time, such that the controller C may identify the weight of the second tape 100′ wound around the second tape fixing roll 300 in real time. If the weight of the second tape fixing roll 300 is less than or equal to a preset weight value, based on the weight information of the second tape fixing roll 300 transferred through the second load cell portion 720, the controller C may determine that the timing for tape replacement has occurred, and operate the fusing unit 500 and the cutting unit 600 to replace the second tape 100′ with the first tape 100, and to feed the first tape 100 to the product assembling unit 1000. As the timing for tape replacement may be accurately determined by measuring in real time the weight of the second tape 100′ to be fed, a tape may be continuously fed to the product assembling unit 1000.

Moreover, if replacement of the first tape 100 is required, the second tape 100′ may be previously provided and the first tape 100 may be replaced with the second tape 100′, and if replacement of the second tape 100′ is required after feeding of the second tape 100′, then the first tape 100 may be previously provided and the second tape 100′ may be replaced with the first tape 100, thereby alternately feeding winding rolls of the first tape 100 and the second tape 100′ to the first tape fixing roll 200 and the second tape fixing roll 300 to continuously feed the tape to the product assembling unit 1000. In other words, the first and second tapes 100 and 100′ may be alternately and continuously provided (e.g., fed) to the product assembling unit 1000, while the first and second tape fixing rolls 200 and 300 are alternately refilled (e.g., each of the first and second tape fixing rolls 200 and 300 may be refilled with a tape during operation of the other one of the first and second tape fixing rolls 200 and 300).

According to the current embodiments, a label adsorbing unit 800 for adsorbing a label attached to the first tape 100 and the second tape 100′ and a vision camera unit 900 (e.g., a camera) disposed adjacent to the label adsorbing unit 800 to detect feeding of the label may be provided. The vision camera unit 900 may count the number of labels L fed to the label adsorbing unit 800 from the first tape 100 and transfer the counted number of labels L to the controller C which may operate the fusing unit 500 and the cutting unit 600 if the number of labels L is greater than or equal to a preset number.

The product assembling unit 1000 may be supplied with a label attached to a small battery pack, and in this case, the label adsorbing unit 800 may adsorb the label L attached to the tape to remove the label L and provide the removed label L to the product assembling unit 1000. In this case, the vision camera unit 900 may recognize the number of labels L continuously attached to the tape and thus fed to the product assembling unit 1000 through a vision camera, and the controller C may determine that a feeding quantity of the first tape 100 is exhausted according to the number of labels L being fed, may determine that replacement of the first tape 100 is required if the number of labels L counted through the vision camera unit 900 is greater than or equal to the preset number, and operate the fusing unit 500 and the cutting unit 600 based on the determination to replace the first tape 100 with the second tape 100′ to continuously feed a tape.

Referring to FIGS. 2 and 6, according to the current embodiment, an alarming unit A (e.g., an alarm) may be further provided. The alarming unit A may generate an alarm according to a signal of the controller C, if the controller C determines that the fusing unit 500 and the cutting unit 600 need to operate.

As illustrated in FIG. 1, a tape transfer roll 400 may be further provided to transfer the first tape 100 and the second tape 100′, from which the label is removed, after the label attached to the first tape 100 and the second tape 100′ is fed. A tape transfer guide roll 410 may be further provided to allow the label-removed tape to be wound therearound and to guide the label-removed tape to the tape transfer roll 400.

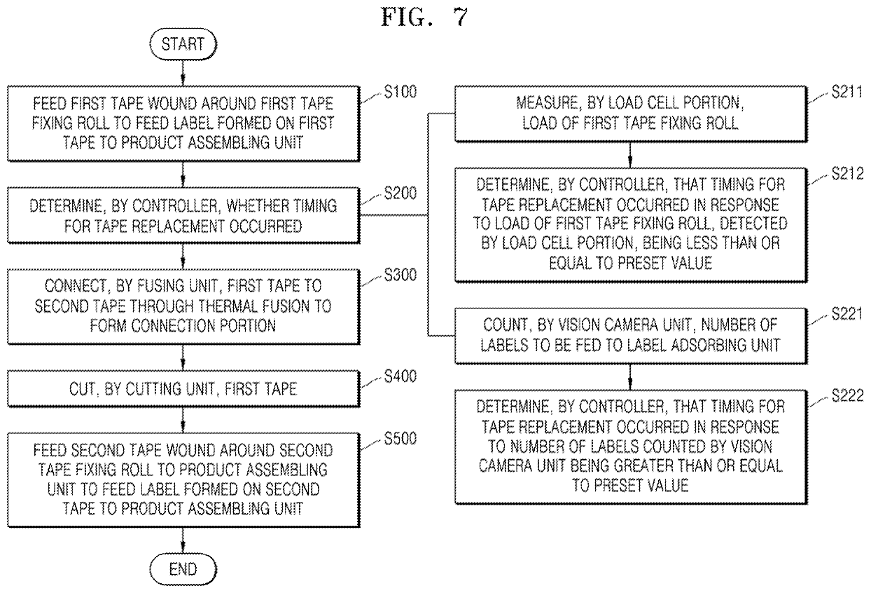

Hereinbelow, a continuous tape feeding method according to embodiments of the present disclosure will be described with reference to FIG. 7. Matters not shown in FIG. 7 will refer to FIGS. 1 to 6. FIG. 7 is a flowchart of a continuous tape feeding method according to embodiments of the present disclosure.

Referring to FIG. 7, the continuous tape feeding method according to embodiments of the present disclosure may include operation S100 of feeding the first tape 100 wound around the first tape fixing roll 200 to the product assembling unit 1000 to feed the label L formed on the first tape 100 to the product assembling unit 1000, operation S200 of the controller C determining whether a timing for tape replacement occurred, operation S300 of the fusing unit 500 connecting the first tape 100 to the second tape 100′ through fusion to form the connection portion CO, operation S400 of the cutting unit 600 cutting the first tape 100, and operation S500 of feeding the second tape 100′ wound around the second tape fixing roll 300 to the product assembling unit 1000 to feed the label formed on the second tape 100′ to the product assembling unit 1000.

In this case, operation S200 of the controller C determining whether the timing for tape replacement occurred may include operation S211 of the load cell portion 700 measuring the load of the first tape fixing roll 200 and operation S212 of the controller C determining that the timing for tape replacement occurred if the load of the first tape fixing roll 200, detected by the load cell portion 700, is less than or equal to the preset value. Operation S200 of the controller C determining whether the timing for tape replacement occurred may also include operation S221 of counting the number of labels fed to the label adsorbing unit 800 and operation S222 of the controller C determining that the timing for tape replacement occurred if the number of labels counted by the vision camera unit 900 is greater than or equal to the preset value. At this time, the cutting unit 600 may cut the first tape 100 portion between the connection portion CO and the first tape fixing roll 200, if the controller C determines that the timing for tape replacement occurred.

If the first tape 100 is fed and then the controller C determines that replacement is required, a feeding route may be changed to the second tape 100′ to continuously feed a tape to the product assembling unit 1000, thereby allowing labels to be continuously fed into the product assembling unit 1000 smoothly. In the continuous tape feeder and the continuous tape feeding method according to embodiments of the present disclosure, the controller may automatically determine a time when a label material formed on the tape is exhausted (e.g., used up), and change a tape feeding route based on the determination, thereby continuously feeding the tape to the product assembling unit.

Connections of lines or connection members between components shown in the drawings are illustrative of functional connections and/or physical or circuit connections, and in practice, may be expressed as alternative or additional various functional connections, physical connections, or circuit connections, e.g., connection between or supports/holders of rolls, the fusing unit, and/or the cutting unit. A designator “the” or similar designators described in the description and the claims may refer to both singular and plural, unless otherwise specifically limited. In addition, when the range is described in the embodiments, the range includes the present disclosure to which an individual value falling within the range is applied (unless stated otherwise), and is the same as the description of an individual value constituting the range in the description of the present disclosure.

When there is no apparent description of the order of operations constituting the method according to the embodiments or a contrary description thereof, the operations may be performed in an appropriate order. However, the present disclosure is not necessarily limited according to the describing order of the operations. The use of all examples or exemplary terms (for example, etc.) in the present disclosure are to simply describe the present disclosure in detail, and unless the range of the present disclosure is not limited by the examples or the exemplary terms unless limited by the claims. In addition, it may be understood by those of ordinary skill in the art that various modifications, combinations, and changes may be made according to design conditions and factors within the scope of the appended claims or equivalents thereof.

By summation and review, when a tape material wound in the form of a roll is exhausted during production of the battery pack, a roll material needs to be replaced after stopping the production process of the battery pack, thereby resulting in production loss corresponding to the replacement time of the roll material. While, in order to continuously feed the tape, an operator visually may identify a timing for replacing the tape roll and connect two rolls to each other by attaching a connecting tape between tapes during the replacement timing, the operator may manually check a roll at the replacement timing and production may be impossible during the roll replacement time, thereby lowering productivity. Also, when the operator manually attaches the connecting tape, the tape may not be attached correctly, and thus, a tape connection portion may be torn, leading to degradation of the feeding quality during tape feeding.

In contrast, one or more embodiments include a continuous tape feeder and a continuous tape feeding method to continuously feed a tape in an automatic manner. That is, a continuous tape feeder, according to embodiments, may include two tapes that are alternately fed (through two feeding routes) to the product assembling unit, after being fused and cut, in accordance with the controller C determination that tape replacement is required.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A continuous tape feeder, comprising:
a first tape fixing roll configured to feed a first tape;
a second tape fixing roll configured to feed a second tape;
a fuser adjacent to the first tape fixing roll, the fuser being configured to connect the first tape to the second tape through fusion to form a connection portion;
a cutter between the fuser and the first tape fixing roll, the cutter being configured to cut a first tape portion between the connection portion and the first tape fixing roll; and
a controller configured to determine a timing for operating the fuser and the cutter.

2. The continuous tape feeder as claimed in claim 1, further comprising a first load cell portion connected to the first tape fixing roll, the first load cell portion being configured to detect a load of the first tape wound around the first tape fixing roll.

3. The continuous tape feeder as claimed in claim 2, wherein the first load cell portion is further connected to the controller, the first load cell portion being configured to transfer the detected load to the controller, and the controller being further configured to operate the fuser and the cutter in response to a comparison between the load of the first load cell portion and a preset value.

4. The continuous tape feeder as claimed in claim 1, further comprising:
a label adsorber configured to adsorb a label attached to the first tape and the second tape; and
a camera arranged adjacent to the label adsorber and configured to detect feeding of the label.

5. The continuous tape feeder as claimed in claim 4, wherein:
the camera is further configured to count a number of labels to be fed to the label adsorber and to transfer the counted number of labels to the controller, and the controller is further configured to operate the fuser and the cutter in response to a comparison between the counted number of labels and a preset value.

6. The continuous tape feeder as claimed in claim 1, further comprising an alarm configured to generate an alarm according to a signal generated by the controller if it is determined that the fuser and the cutter need to operate.

7. The continuous tape feeder as claimed in claim 1, further comprising a tape transfer roll configured to transfer the first tape and the second tape, after a label attached to the first tape and the second tape is removed.

8. The continuous tape feeder as claimed in claim 1, wherein the first tape fixing roll and the second tape fixing roll respectively include a first tape guide roll and a second tape guide roll, the first tape guide roll and the second tape guide roll being arranged to define transfer paths for the first tape and the second tape, respectively.

9. The continuous tape feeder as claimed in claim 8, wherein the transfer paths for the first tape and the second tape are through the fuser.

10. A continuous tape feeding method, comprising:
feeding a first tape wound around a first tape fixing roll to a product assembler, such that a label from the first tape is fed to the product assembler;
determining, by a controller, whether a timing for a tape replacement occurred;
connecting, by a fuser, the first tape to a second tape through fusion to form a connection portion;
cutting, by a cutter, the first tape; and
feeding the second tape wound around a second tape fixing roll to the product assembler, such that a label from the second tape is fed to the product assembler.

11. The continuous tape feeding method as claimed in claim 10, wherein determining by the controller includes:
measuring, by a load cell portion, a load of the first tape fixing roll; and
determining, by the controller, that the timing for the tape replacement occurred in response to the load of the first tape fixing roll detected by the load cell portion being less than or equal to a preset value.

12. The continuous tape feeding method as claimed in claim 10, wherein determining by the controller includes:
counting, by a camera, a number of labels to be fed to a label adsorber; and
determining, by the controller, that the timing for the tape replacement occurred in response to the number of labels counted by the camera being greater than or equal to a preset value.

13. The continuous tape feeding method as claimed in claim 10, further comprising cutting, by the cutter, a first tape portion between the connection portion and the first tape fixing roll.

14. The continuous tape feeding method as claimed in claim 10, further comprising, after the label attached to the first tape and the second tape is fed to the product assembler, transferring the first tape and the second tape, from which the label is removed, via a tape transfer roll.
